(19) United States
(12) Patent Application Publication
(10) Pub. No.: US 2008/0222189 A1
(43) Pub. Date: Sep. 11, 2008

(54) Associating multidimensional data models

(75) Inventors: Oleg Gregory Ovanesyan, Redmond, WA (US); Catalin Ion Sipos, Redmond, WA (US); Eric Scott Danas, Sammamish, WA (US); Lewis C. Levin, Seattle, WA (US); Xiaohong Yang, Sammamish, WA (US); Parul Manek, Redmond, WA (US); Peter Anthony Bull, Redmond, WA (US); Vladimir Sergeyev, Redmond, WA (US); Alvaro Peon Sanchez, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/714,308

(22) Filed: Mar. 6, 2007

(51) Int. Cl. G06F 17/00

(52) U.S. Cl. 707/102; 707/E17.056

(57) ABSTRACT

A source multidimensional data model is associated with a target multidimensional data model, for purposes of, for example, copying or linking data between the source and the target. Individual dimensions are mapped from the source to the target. Within each mapped dimension, individual dimension members are mapped from the source to the target. The resulting association may be stored and utilized to generate executable statements for copying or linking data between the source and the target.

### BACKGROUND

Business intelligence (BI) processes have become an integral part of many modern corporations. Multidimensional databases and On Line Analytical Processing (OLAP) tools can be vital components of modern BI technologies. Such databases and tools may be used to store and analyze operational, financial, and other metrics of an organization indexed along a multitude of dimensions. An organization can utilize such BI technologies to quickly compare and analyze these metrics in the most relevant context. For example, a chart of financial accounts may represent a standard dimension for a multidimensional financial data model. Each account (e.g., gross revenue or earnings per share) may have a value associated with it, but the value for a particular account may vary over a number of other dimensions, including time, geographic region, corporate division, product, or scenario, for example. Such multidimensional data models are sometimes represented as OLAP cubes.

As organizations have grown and BI technologies have advanced, the need for and use of multidimensional data models has also grown. Different departments (e.g., accounting or operations) or divisions within an organization may maintain separate data models utilizing different sets of dimensions depending on varying analysis needs. Often, data from disparate data models are required to be exchanged and shared. For example, financial or operational data may need to be rolled up from separate divisions for corporate reporting. For different organizations, this process of moving multidimensional data between data models has been cumbersome, expensive, and fraught with potential errors. Frequently, database coders will create stored procedures by hand or use a query language such as structured query language (SQL) or multidimensional expressions (MDX) to move data between multidimensional models. Sometimes, coders will use a database tool to copy data between models. However, existing tools and hand-coded queries require an excessive level of technical knowledge that most users of multidimensional data models do not have.

It is with respect to these considerations and others that the disclosure made herein is provided.

### SUMMARY

Technologies are described herein for associating (or mapping) multidimensional data models. Through aspects presented herein, an association between two multidimensional data models can be assembled by a user. The association can be used to copy data from a source data model to a target data model. The association may also be used, for example, to link information between the source and target data models. The association may be assembled by visually mapping model dimensions and dimension members between the two models.

According to one aspect presented herein, a method provides for receiving a selection of source and target multidimensional data models from a user. The user then maps the dimensions of the source model to the respective dimensions of the target model. For each mapped dimension, the user then maps the source dimension members to the target dimension members. The resulting association is then stored for use in copying data from the source to the target. The association can be used to ensure that differences in dimension and member structure and/or labeling do not prevent multidimensional data from being properly copied.

According to another aspect presented herein, a system includes a source multidimensional data model, a target multidimensional data model, and a data model association application. The data model association application enables a user to select the source and the target, and to map dimensions from the source to the target. For each mapped dimension, the data model association application enables the user to map individual dimension members from the source to the target, ensuring that the stored association will be used to properly copy multidimensional data from the source model to the target model.

According to an additional aspect presented herein, a method provides for utilizing a stored multidimensional data model association to copy data from a source data model to a target data model. The association includes information identifying the source and target data models, information mapping the dimensions of the source data model to the target data model, and information mapping dimension members from the source to the target. The association is used to generate executable statements such as database queries. Executing the executable statements results in data being copied from the source data model to the target data model.

The above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a depiction of a multidimensional data model provided in one or more embodiments described herein;

FIG. 2 is a depiction of associating a source data model with a target data model according to one or more embodiments described herein;

FIG. 3 is a class diagram depicting classes used in creating and storing associations according to one or more embodiments described herein;

FIG. 4 is a user interface diagram depicting an interface for creating a new association according to one or more embodiments described herein;

FIG. 5 is a user interface diagram depicting an interface for mapping model dimensions according to one or more embodiments described herein;

FIG. 6 is a user interface diagram depicting an interface for mapping dimension members according to one or more embodiments described herein;

FIG. 7 is a user interface diagram depicting an interface for creating associations, dimension mappings, and member mappings according to one or more embodiments described herein;

FIG. 8 is a flow diagram depicting a process for associating two multidimensional data models according to one or more embodiments described herein;

FIGS. 9A and 9B are flow diagrams depicting processes for copying multidimensional data between two models utilizing an association according to one or more embodiments described herein; and

FIG. 10 is a computer architecture diagram depicting a computer architecture suitable for implementing one or more embodiments of a computer system capable of associating multidimensional data models.

### DETAILED DESCRIPTION

The following detailed description is directed to technologies for associating multidimensional data models. As will be discussed in greater detail below, data can be associated between two multidimensional data models by mapping dimensions and dimension members between a source multidimensional data model and a target multidimensional data model. A multidimensional data model includes data stored and indexed over multiple dimensions. By receiving information identifying a source model and a target model, and at least one dimension mapping, moving or linking data between the source to the target can be simplified and automated. An explicit association may further simplify subsequent data movements when the structure of either source or target multidimensional models changes.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other configurations, including hand-held devices, embedded systems, multiprocessor and clustered systems, microprocessor-based or programmable consumer electronics, minicomputers, and mainframe computers, for example.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for associating multidimensional data models will be described.

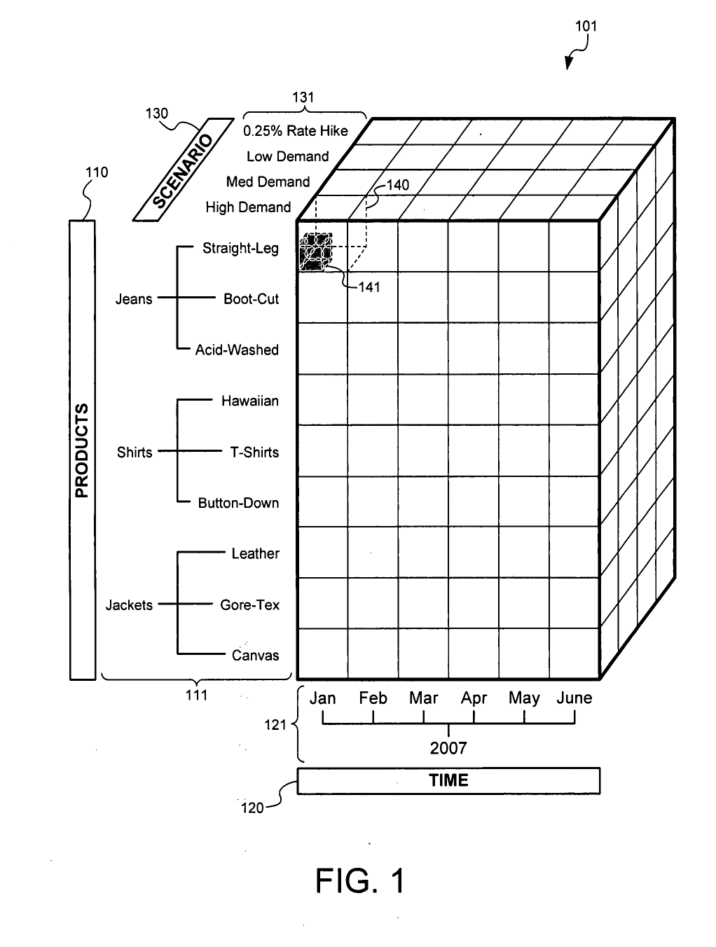

In particular, FIG. 1 is a depiction of a multidimensional data model 101 can be represented as a three-dimensional object, such as a cube. The multidimensional data model 101, however, may include more than three dimensions. As a result, a three-dimensional representation such as that shown may ignore or make assumptions about dimensions not depicted. In the model of FIG. 1, the dimensions shown are product 110, time 120, and scenario 130. Each dimension includes a set of members, including a set of product members 111, a set of time members 121, and a set of scenario members 131. Dimension members can be hierarchical, as with the product members 111 and the time members 121. Hierarchical members are subdivided into groupings associated with higher level members, such as jeans and shirts in the product members 111 or the year 2007 in the time members 121.

At the intersection 140 of three members, represented by the tuple [Product].[Jeans]. [Straight-Leg], [Time]. [2007]. [Jan], [Scenario].[High Demand], one or more values 141 (also called facts) may be stored. In this example, a value may be the expected demand for straight-leg jeans in January of 2007. Other values may include, for example, incremental cost, expected revenue, and manufacturing capacity. These additional facts may be stored as members of an unseen dimension (e.g., account), or simply as additional values or facts stored at the intersection 140.

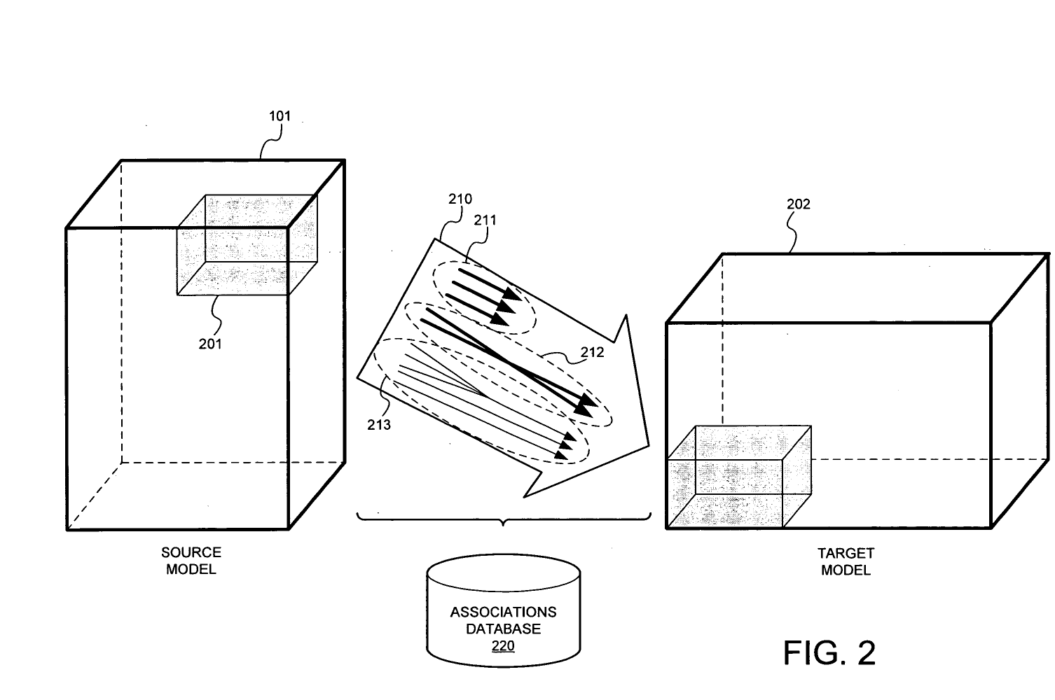

FIG. 2 depicts the multidimensional data model 101 of FIG. 1 as the source model of an association 210 according to one or more embodiments. Here, a sub dataset 201 from the source model 101 is being associated with a target model 202. For example, financial data from a subsidiary may reside in the source model 101, and reporting data for a parent company may reside in the target model 202. Subsequently, the sub dataset 201 will need to be copied from the source model 101 to the target model 202 on a regular basis, such as quarterly.

In order to copy the sub dataset 201, an association 210 is created linking the source model 101 and the target model 202. The association 210 stores information identifying the source model 101 and the target model 202. Additional information stored with the association 210 may include, for example, location information for the two models, frequency information for executing the association. All of the information comprising the association 210 may be stored for future use, such as in an associations database 220.

The association 210 also includes information about scoped dimensions 211, dimension mappings 212, and member mappings 213. A scoped dimension 211 is a dimension that has been filtered for a particular member or set of members. By specifying the scoped dimensions 211, the sub dataset 201 can be identified. Dimension mappings 212 contain information matching a source dimension in the source model 101 to a target dimension in the target model 202. Frequently, the same dimension will have the same or similar name or label in both models 101, 202, and so matching the source dimension and target dimension for a dimension mapping 212 may be automated. For example, a source time dimension can easily be mapped to a target time dimension. However, some dimension mappings 212 may not be identically or similarly labeled, and so a user will have to manually indicate the mapping, for example a source product dimension may map to a target product family dimension. Furthermore, such mapping may be converted from existing data sources, if available. It should be noted that the dimensionality (the number of dimensions) of the source and of the target multidimensional models does not have to be equal.

A member mapping 213 works in a fashion similar to a dimension mapping 212. Once a dimension has been mapped, the individual members of that dimension must be mapped. The mappings allow values and facts to be properly dimensioned at the target model 202 in spite of any differences in structure or labels. As above, members that have the same or similar labels can be automatically mapped between the source model 101 and the target model 202. However, some members may need to be manually mapped. For example, the source scenario member “High Demand” may be mapped to the target scenario member “Optimistic Plan.” Furthermore, rule-based mapping or pattern-based mapping may be used to further automate the mapping process.

Some member mappings 213 may require aggregation functions and/or formulas in order to map values between the source model 101 and the target model 202. For example, the time dimension on the source model uses years and months, but the time dimension on the target model uses fiscal quarters. In this situation, three month members in the source time dimension would be aggregated and mapped to a specific quarter in the target time dimension (e.g., “Jan”, “Feb”, and “Mar” mapped to “Q1”). Aggregation functions may include, for example, sum, average, maximum, and minimum. A sum function adds the values of the multiple source members and place the transformed result in the single target member. An average function averages the values of the multiple source members. A maximum or minimum function finds the respective maximum or minimum value of the multiple source members and places that value in the single target member. Reverse aggregation functions, such as a split for example, may also be utilized to distribute a single source value, or a portion thereof, to multiple target values.

The aggregation function used may change depending on the particular value, and so multiple associations 210 may need to be created to accommodate the different aggregation cases. For example, manufacturing capacity may be averaged when mapping months to quarters, but revenue may be summed when mapping months to quarters.

The association 210 may further vary based on time or scenario, for example. In other words, if the structure of either the source or destination model varies over time, the association may be modified to account for such structural changes. Likewise, multiple associations 210 may be generated to account for variations in model structures over time and scenario, or along other dimensions.

Once the association 210 has been defined, along with the scoped dimensions 211, the dimension mappings 212, and the member mappings 213, information defining the association 210 can be stored for future use, such as in the associations database 220. The associations database 220 may reside with the source model 101 or target model 202, or within a separate database or computer system.

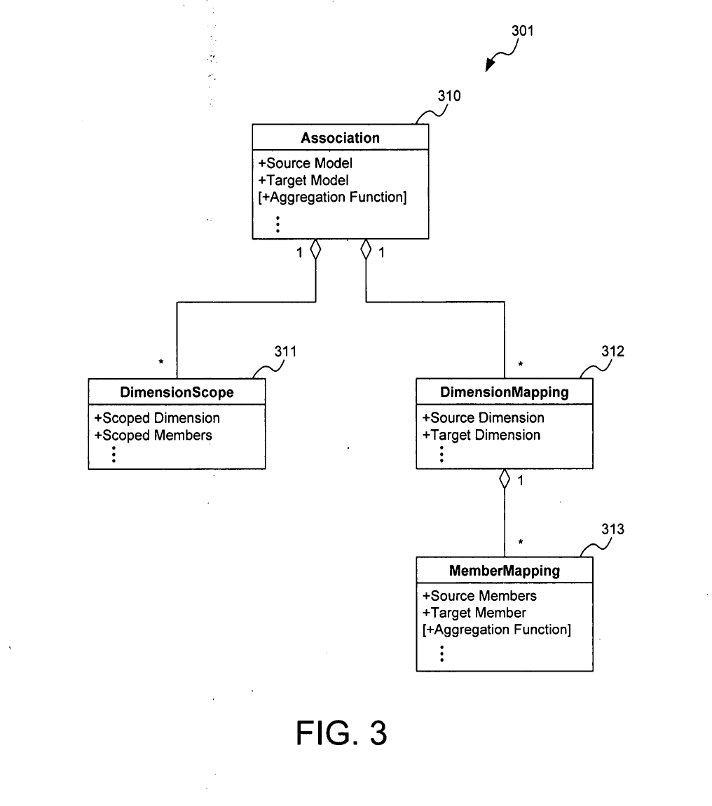

Additional detail regarding the storage and use of the association 210 will now be discussed with respect to FIG. 3. FIG. 3 illustrates a class diagram 301 depicting classes that may be used in creating, manipulating, and storing the associations 220 in one embodiment. The class diagram 301 is intended as an example, and other classes or data models may be utilized. The classes depicted in the class diagram 301 are representations of one or more implementations. The classes depicted may correlate with the properties or members of an object-oriented class and/or the fields of a relational database table, for example. The properties depicted with each class are not intended to be exclusive of other properties, fields, or methods.

The Association class 310 may be used to store methods and properties associated with an association 210. Properties of the Association class 310 include identifiers of the source model 101 and the target model 202. The DimensionScope class 311 includes properties associated with scoped dimensions 211, including an identifier of the dimension, and the dimension members used to filter the scoped dimension 211. An instance of the DimensionScope class 311 can have one parent instance of the Association class 310, but the Association instance can have multiple DimensionScope instances.

The DimensionMapping class 312 may be used to store methods and properties associated with a dimension mapping 212. Properties include a source dimension and a target dimension for the mapping. As with the DimensionScope class 311, an instance of the DimensionMapping class 312 can have one parent instance of the Association class 310, but the Association instance can have multiple DimensionMapping instances.

The MemberMapping class 313 may be used to store methods and properties associated with a particular member mapping 213. Properties include identifiers of one or more source dimension members and an identifier of a target dimension member. In addition, when more than one source dimension member is specified, the aggregation function to be used for handling the transform is identified. An instance of the MemberMapping class 313 can have one parent instance of the DimensionMapping class 312, but the DimensionMapping instance can have multiple MemberMapping instances.

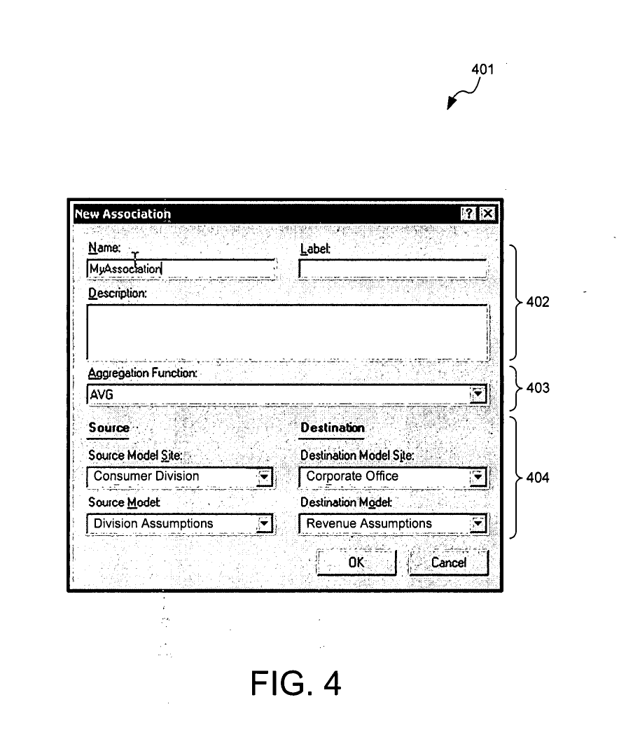

FIGS. 4-7 depict examples of user interfaces that may be used to create, manipulate, store, and execute multidimensional data model associations 210. The interfaces provided are merely examples and may be implemented using a dedicated software application or a configurable interface such as an Internet web browser. Other interface implementations not shown may fall within the scope of the claims set forth below.

FIG. 4 depicts an example of an association interface 401 for creating and modifying the association 210. The interface 401 provides entry fields 402 for naming, labeling, and describing a new association 210. Also provided is an aggregation selector 403 through which a user may identify a primary or default aggregation function to be utilized with the association 210. The aggregation selector 403 limits a user's choices to known aggregation functions. Finally, the interface 401 provides model selectors 404 for locating and identifying the source model 101 and the target model 202. The values supplied in the model selectors 404 may be limited to model locations and names with which the user has previously worked, may include browsing tools to find other accessible models, or may allow free form entry of the location and identifying information. The interface 401 may be displayed on a screen or otherwise utilized when creating a new association 210 or updating an existing association.

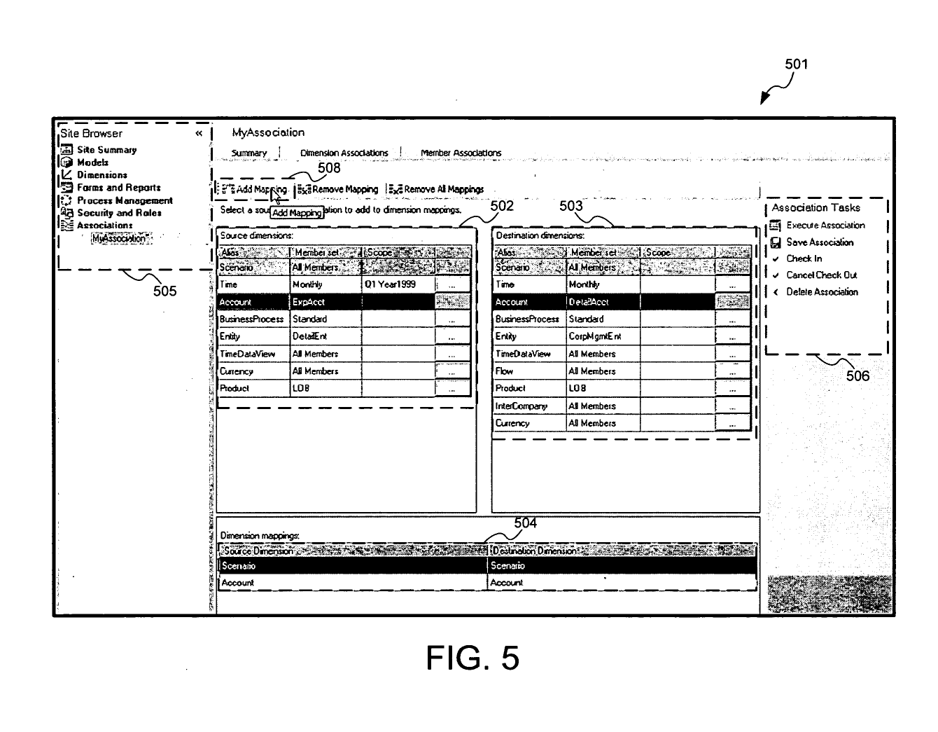

Once an association 210 has been created using the association interface 401, the dimension-mapping interface 501 of FIG. 5 can be used for mapping dimensions from the source model 101 to the target model 202. The interface 501 may be displayed on a screen when creating a new association 210 or managing association dimensions. The interface 501 includes a site browser 505 allowing access to other multidimensional data models 101 and associations 210. The interface 501 also provides several lists of dimensions, including a source dimension list 502, a target dimension list 503, and a mapped dimension list 504.

The source dimension list 502 includes information about each of the dimensions in the source multidimensional data model 101. This includes the dimension name, an associated member set, and a scoped dimension 211, if any. The target dimension list 503 includes similar information for the dimensions of the target multidimensional data model 202. As a user clicks on dimensions on either dimension list 502, 503, any mapped dimension on the other list may be indicated, such as by highlighting, as shown with the Account dimensions. Clicking on the “Add Mapping” button 508 triggers a routine to create a new dimension mapping between selected dimensions on the source dimension list 502 and the target dimension list 503. Similarly, a user may be able to select and “drag” a dimension from the source dimension list 502 to the target dimension list 503 in order to create a new dimension mapping. It should be appreciated that the interface 501 is merely illustrative and that other user interface metaphors may be used to create the mapping. The mapped dimension list 504 shows the pairs of dimensions already mapped between the source and target dimensions.

The interface 501 also includes a task panel 506, including user interface objects corresponding to tasks available for the currently selected association 210. Among the tasks available in the task panel 506 is “Execute Association,” which when selected uses the association 210 to copy data from the source model 101 to the target model 202. Executing the association may first require creating or updating a set of queries written in SQL or MDX or require that one or more stored procedures be created or updated prior to executing. The queries or procedures may be stored with the association 210 in the associations database 220. If no changes have been made to the association 210, then execution may be able to occur without first updating the underlying queries or procedures. Once executed, the queries and/or procedures update the information in the target model 202 from the source model 101. Other tasks that may be initiated through the task panel 506 include saving or updating the association, checking the association in or out from source control, and deleting the association, for example.

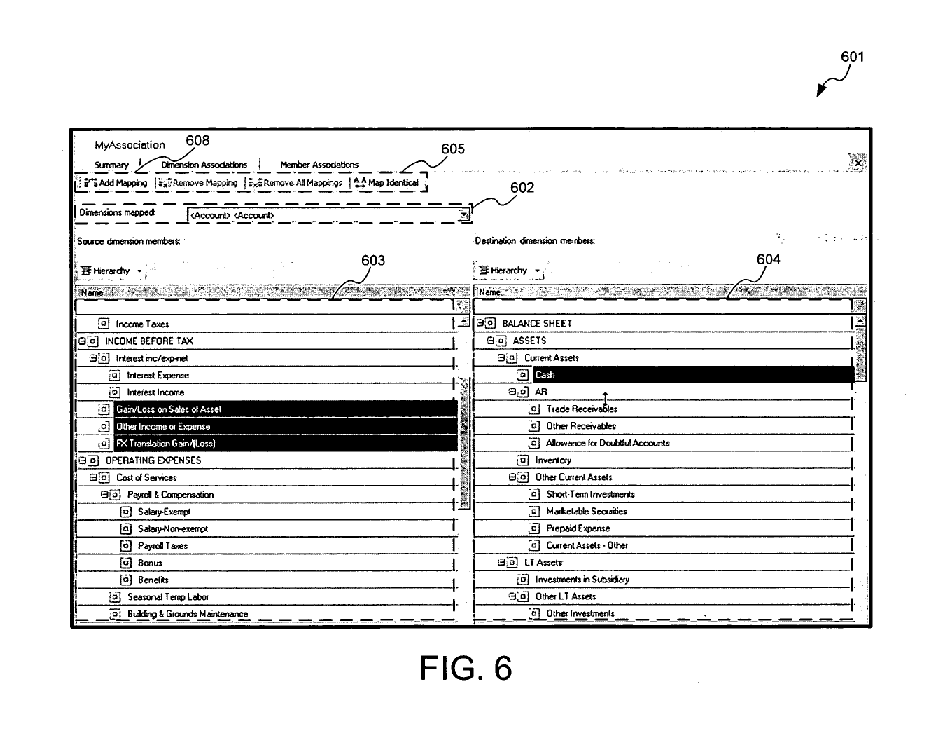

Once source and target model dimensions have been mapped or scoped using the interface 501, a member mapping interface 601 shown in FIG. 6 may be utilized to map individual members within each mapped dimension. The member mapping interface 601 may be displayed on a screen to allow a user to map individual dimension members between the source model 101 and the target model 102. Using a dimension selector 602, the user can select a pair of mapped dimensions to map individual dimension members. Selecting a pair of mapped dimensions updates a source dimension member list 603 and a target dimension member list 604 to be updated with the available members for the respective dimensions. Individual members may be mapped by dragging from the source dimension member list 603 to the target dimension member list 604, or by clicking on the “Add Mapping” button 608 in the button bar 605. Other interface metaphors for mapping may be utilized. In addition, the “Map Identical” button in the button bar 605 may be used to map identically identified members from the source dimension member list 603 to the target dimension member list 604. Identical members may need to occupy the same location within identical hierarchies in order to be considered identical. Once a user has completed mapping all of the relevant members for a particular set of mapped dimensions, the user can change the dimension selector 602 and begin mapping another set of members.

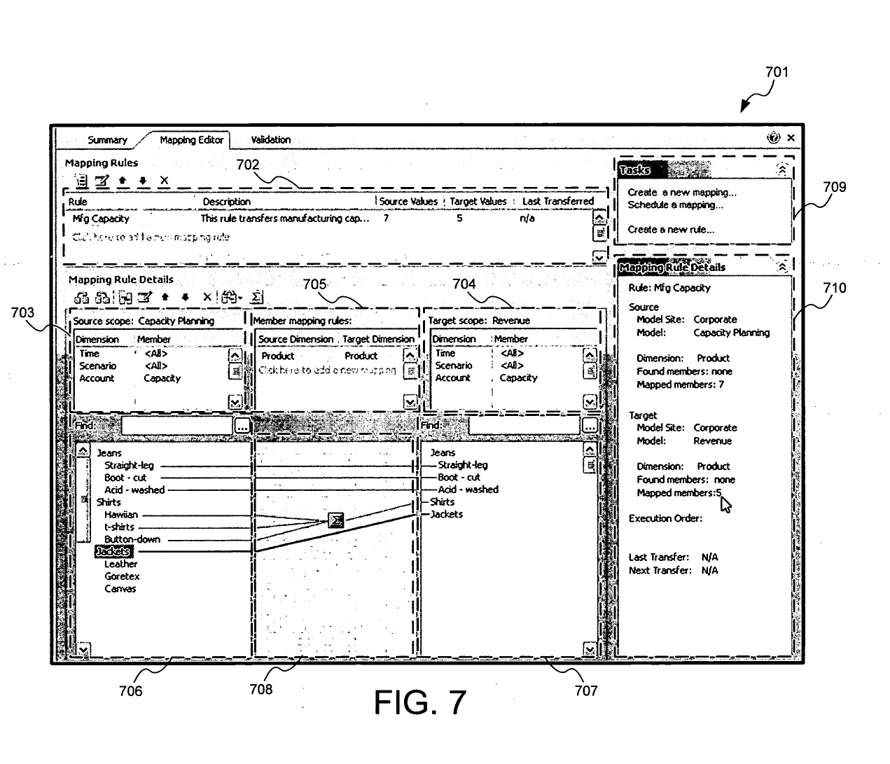

FIG. 7 depicts another example of an association interface 701 for creating and manipulating associations and their accompanying dimension mappings and member mappings. Here, association list 702 shows “Mapping Rules.” The mapping rules are the same as associations 210. A user can review information about a current association 210, or create a new association from this list. For the currently selected association, the source dimension list 703 and the target dimension list 704 are populated with the dimensions of their respective models. Once a source dimension has been mapped to a target dimension, they both appear in a mapped dimension list 705. Selecting a mapped pair of dimensions in the mapped dimension list 705 populates both a source dimension member list 706 and a target dimension member list 707. As mappings are created between the two dimension member lists 706, 707, the mapping panel 708 reveals the mapping relationships among the source and target members. This includes graphically showing direct mappings, as well as aggregated mappings when multiple source members map to a single target member. The lists 706 and 707 may each include a search input to allow a user to enter text in order to find particular members quickly.

The association interface 701 also includes a task panel 709 that updates depending on the current activity of the user. Similar to the task panel 506, the tasks shown include saving and executing the current association 210, as well as scheduling an association execution. Finally, the association interface 701 has an association summary area 710. The summary area 710 includes information about the source model 101 and the target model 202, including the number of mapped members for each mapped dimension.

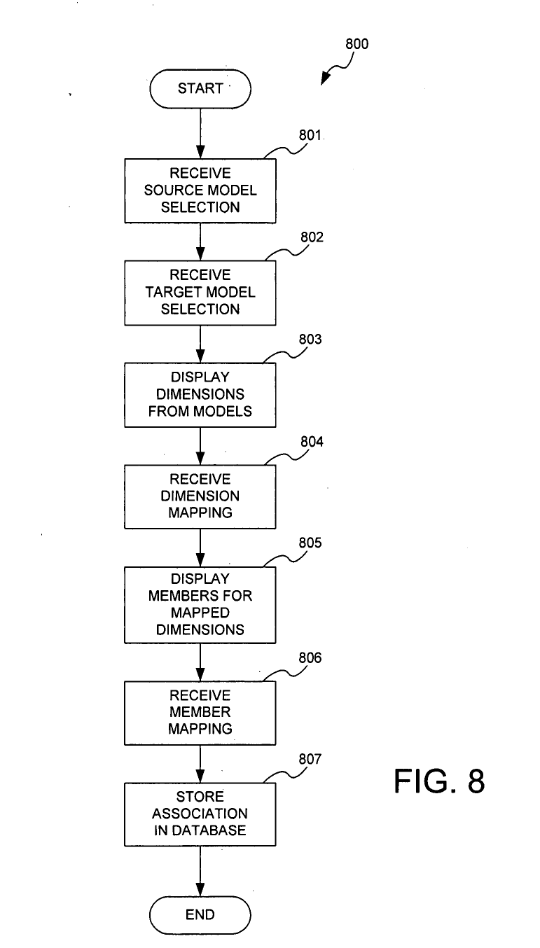

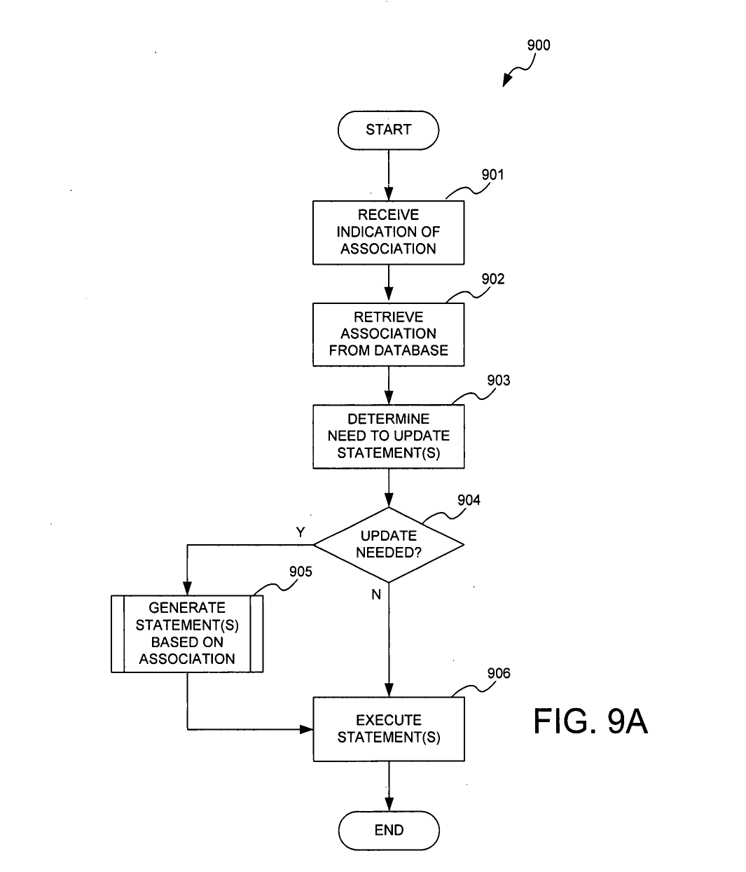

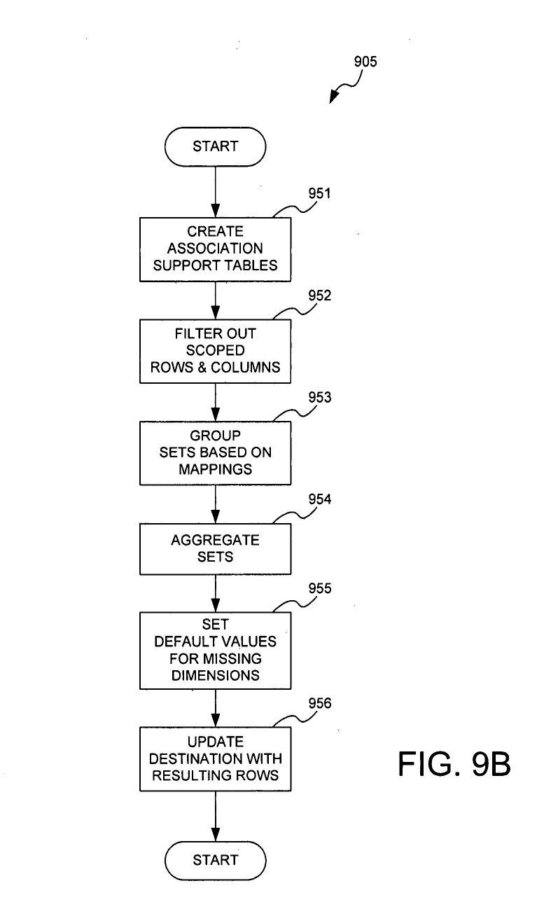

Referring now to FIGS. 8, 9A, and 9B, additional details will be provided regarding the embodiments presented herein for associating multidimensional data models. It should be appreciated that the logical operations of FIGS. 8, 9A, and 9B, and described elsewhere herein are implemented (1) as a sequence of computer implemented acts or program modules running on a computing system and/or (2) as interconnected machine logic circuits or circuit modules within a computing system. The implementation is a matter of choice dependent on the performance requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in FIGS. 8, 9A, and 9B, and described herein. These operations may also be performed in a different order than those described herein with respect to the figures.

FIG. 8 is a flow diagram showing a routine 800 that illustrates the operation of a computer system, described below, when associating multidimensional data models. The routine 800 begins at operation 801, where a selection of a source multidimensional data model 101 is received from a user. This selection may be received via a user interface such as via the model selectors 404 of the interface 401. At operation 802, a selection of a target multidimensional data model 202 is received from the user in a similar fashion. In both operations 801 and 802, the data model may be selected from a list of accessible data models. The two selected data models are then accessed to retrieve lists of available dimensions from each. At operation 803, the dimensions of both the source model 101 and the target model 202 are displayed in a fashion enabling a user to indicate a mapping of a source dimension to a target dimension. The source dimension list 502 and the target dimension list 503 of the interface 501 serve as examples of such a display.

Continuing on to operation 804, the user selects a source dimension and a target dimension, which are used to generate a dimension mapping. The selection may be indicated again utilizing a user interface such as the interface 501. At operation 805, the selected source and target dimensions are accessed in order to retrieve and display the list of available members for each dimension. The interface 601 depicts the examples of the source dimension member list 603 and the target dimension member list 604. The members may be displayed hierarchically as with the lists 603 and 604, alphabetically, or in any other convenient way. A user then selects one or more members from the source dimension member list 603 and one member from the target dimension member list 604 to indicate a member mapping, which is received at operation 806. Additional dimension and member mappings may be received in a similar fashion.

The resulting mappings and selections are then associated with the association 210 for storage at operation 807, such as in the associations database 220. Other information stored with the association 210 may include queries or stored procedures based on the selections and mappings of the user. Also, date & time information about recent updates and executions may also be stored. Such information may be utilized when determining whether an update of the underlying queries or procedures may be needed. For example, if a new dimension has been added to the source or target models, additional dimension scopes and/or dimension mappings may be required before regenerating the queries or procedures.

FIG. 9A is a flow diagram showing a routine 900 that illustrates the operation of a computer system, described below, when executing a multidimensional data model association. The routine 900 begins at operation 901, where an indication of an association 210 is received. The indication may be based on a currently selected association in a list of associations, or it may be based on a scheduled execution of a particular association. At operation 902, the selected association is retrieved, including any queries or procedures stored with the association. Some queries or associations may be stored separate from the associations database 220 (e.g., stored procedures in the source multidimensional data model), but the association 210 may include references to such separately stored procedures or queries.

Based on changes in the respective source and target data models, the need for the procedures or queries to be regenerated may be determined at operation 903. This operation may involve comparing timestamps, database change logs, or other indications of a need for an update. If, at decision 904, an update is needed, then at subprocess 905, the executable statements are regenerated. The process of utilizing information stored with the association 210 to generate executable statements such as queries, procedures, scripts, or other forms of code can take several forms. Each member mapping may require a separate SQL or MDX statement, for example. Likewise, multiple member mappings may be consolidated into one or more complex scripts, statements, or procedures. If no update is needed, or once the executable statement(s) have been updated, then at operation 906, the executable statements are executed, copying data from the source model 101 to the target model 202.

FIG. 9B is a flow diagram showing an example of how subprocess 905 may generate executable statements based on the association. Other subprocesses may also be utilized. The operations shown may be part of process 900, but also may be used by any other process for executing an association between multidimensional data models. The operations shown may be performed, for example, by a set of stored executable statements, such as SQL or MDX statements, or by another dynamic programming or scripting language. The subprocess 905 begins at operation 951, where temporary support tables may be created based on the information stored with the association. For example, a support member mapping table may be generated for each mapped dimension. This table may be used to map source dimension members to target dimension members, either by member label, an identification number, or both. The table may also store information about a debit or credit sign to be utilized when mapping and/or aggregating source members. Additional support tables may be required to store information about each scoped dimension, for example.

At operation 952, one or more underlying source multidimensional fact table may be filtered to exclude information not pertaining to the association. For example, the information stored in one or more support tables pertaining to scoped dimensions may be used to exclude and/or include certain dimension members for each dimension. Additionally, source dimensions that are not associated with particular target dimensions may be excluded entirely. At operation 953, groups of related information may be combined and/or relabeled into sets. These sets may represent information where multiple dimension members may be mapped into a single target dimension member, for example. New target dimension and member labels may also be applied during operation 953.

At operation 954, values stored with certain source dimension members may be aggregated for mapping into a single target dimension member. This may include, for example, summing or averaging values to produce an aggregated result for inclusion in the target multidimensional model. At operation 955, any target dimensions for which no source dimension is mapped may be added to the information, utilizing assigned default dimension members for the information to be copied. Ultimately, one or more temporary tables storing rows of information to be used to update the target multidimensional model may be created by operations 951 through 955. At operation 956, these resulting table rows may then either be inserted into the target multidimensional model as new information, or used to update or replace existing information in the target multidimensional model.

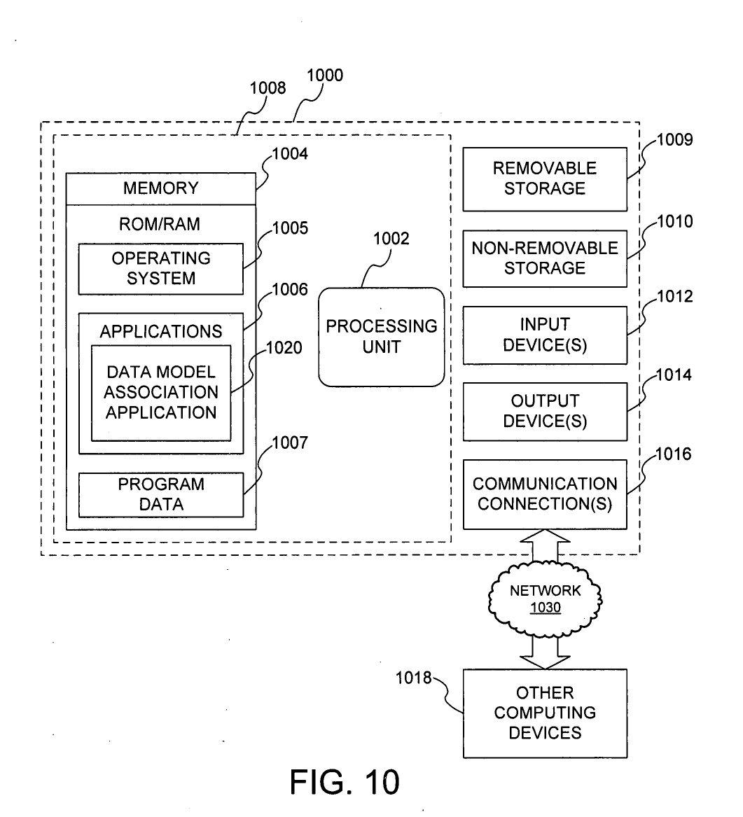

With reference to FIG. 10, embodiments described herein may include a computing system, such as the computing system 1000. In a basic configuration 1008, the computing system 1000 includes at least one processing unit 1002 and a memory 1004. The processing unit 1002 may include one or more microprocessors, microcontrollers, co-processors, field programmable gate arrays (FPGAs), complex programmable logic devices (CPLDs), application specific integrated circuits (ASICs), and other devices capable of executing the methods and operations set forth below. Depending on the configuration of the computing system 1000, the memory 1004 may be volatile (e.g., Random Access Memory (RAM)), non-volatile (e.g., Read-Only Memory (ROM), flash memory), or some combination thereof. The memory 1004 serves as a storage location for an operating system 1005, one or more applications 1006, and may include program data 1007, as well as other modules and procedures.

In various embodiments, the applications 1006 include a data model association application 1020, an application including similar logic, or any other set of instructions comprising such logic. It should be noted that the logic of the data model association application 1020 may be distributed and/or shared across multiple devices, including computing system 1000. More information regarding the function of the data model association application 1020 has been provided above.

The computing system 1000 may include additional features and functionality other than the features shown within dashed-line box 1008. For example, the computing system 1000 may include additional data storage components, including both removable storage 1009 (e.g., floppy disks, memory cards, compact discs (CDs), digital video discs (DVDs), external hard drives, universal serial bus (USB) drives and non-removable storage 1010 (e.g., magnetic hard drives).

Computer storage media may include media implemented in any method or technology for the storage of information, including computer readable instructions, data structures, program modules, or other data. The memory 1004, the removable storage 1009, and the non-removable storage 1010 are all examples of computer storage media. Further examples of computer storage media include RAM, ROM, electrically-erasable programmable ROM (EEPROM), flash memory, CD-ROM, DVD, cassettes, magnetic tape, and magnetic disks. Any such computer storage media may be accessed by components which are a part of the computing system 1000, or which are external to the computing system 1000 and connected via a communications link (e.g., Bluetooth®, USB, parallel, serial, infrared).

The computing system 1000 may also include one or more input devices 1012 for accepting user input. Examples of the input devices 1012 include a keyboard, mouse, digitizing pen, microphone, touchpad, touch-display, and combinations thereof. Similarly, the computing system 1000 may include output devices 1014 such as video displays, speakers, printers, and combinations thereof. It should be understood that the computing system 1000 may also include additional forms of storage, input, and output devices. The input devices 1012 and the output devices 1014 may include communication ports and associated hardware for communicating with external input and output devices rather than including the devices within the computing system 1000.

The computing system 1000 includes one or more communication connections 1016 that include hardware and/or software which enable the computing system 1000 to communicate with other computing devices 1018 over a network 1030. The computing device 1018 may include a server storing one or both of the source multidimensional data model 101 and the target multidimensional data model 202. In addition, the computing device 1018 may serve as an execution platform for the data model association application 1020 described above. A user may access the data model association application 1020 utilizing a web browser or other program in this situation.

The network 1030 may include a wireless network such as, but not limited to, a Wireless Local Area Network (WLAN) such as a WiFi network, a Wireless Wide Area Network (WWAN), a Wireless Personal Area Network (WPAN) such as Bluetooth®, a Wireless Metropolitan Area Network (WMAN) such as a WiMAX network, a cellular network, and/or a satellite network. Alternatively, the network 130 may include a wired network such as, but not limited to, a cable television network, a telecommunications network, a wired Wide Area Network (WAN), a wired (Local Area Network) LAN such as the Ethernet, a wired Personal Area Network (PAN), and/or a wired Metropolitan Area Network (MAN). The network 1030 may also include any combination of the network varieties described above.

Communication media, in the form of computer readable instructions, data structures, program modules, or other data in a modulated data signal, may be shared with and by the computing system 1000 via the communication connection 1016. Modulated data signal may mean a signal that has one or more of its characteristics set or changed in such a manner as to encode information in the signal, and may include a modulated carrier wave or other transport mechanism.

Based on the foregoing, it should be appreciated that technologies for associating multidimensional data models are provided herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the subject matter set forth in the following claims.

What is claimed is:

1. A method for associating two multidimensional data models, the method comprising:
receiving a source selection of a source multidimensional data model;
receiving a target selection of a target multidimensional data model;
receiving a dimension mapping, wherein the dimension mapping includes a first source dimension from the source multidimensional data model and a first target dimension from the target multidimensional data model;
receiving a member mapping, wherein the member mapping includes at least one source member from the first source dimension and a target member from the first target dimension; and
storing the source selection, the target selection, the dimension mapping, and the member mapping as parts of an association between the source multidimensional data model and the target multidimensional data model.

2. The method of claim 1, further comprising copying data from the source multidimensional data model to the target multidimensional data model utilizing the association.

3. The method of claim 2, wherein copying data from the source multidimensional data model to the target multidimensional data model comprises:
constructing a database query according to the association; and
executing the database query to copy data from the source multidimensional data model to the target multidimensional data model.

4. The method of claim 2, wherein copying data from the source multidimensional data model to the target multidimensional data model comprises:
creating a stored procedure according to the association; and
executing the stored procedure to copy data from the source multidimensional data model to the target multidimensional data model.

5. The method of claim 1, wherein receiving the member mapping includes:
receiving a selection of a plurality of source members for mapping to the target member; and
receiving an indication of an aggregation function for use in conjunction with the member mapping.

6. The method of claim 1, further comprising receiving a scoped dimension of a second source dimension, wherein the scoped dimension is limited to a single dimension member.

7. The method of claim 1, wherein receiving the dimension mapping includes:
displaying a source dimension list of available dimensions from the source multidimensional data model;
displaying a target dimension list of available dimensions from the target multidimensional data model;
receiving an indication of the first source dimension from the source dimension list; and
receiving an indication of the first target dimension from the target dimension list.

8. The method of claim 7, wherein receiving the member mapping includes:
displaying a source dimension member list of available dimension members from the first source dimension;
displaying a target dimension member list of available dimension member from the first target dimension;
receiving an indication of the at least one source member from the source dimension member list; and
receiving an indication of the target member from the target dimension member list.

9. A system for associating multidimensional data models, the system comprising:
a data model association application, including instructions which, when executed by a processor, cause the processor to
receive a source selection of a source multidimensional data model,
receive a target selection of a target multidimensional data model,
receive a selection of a source dimension from a plurality of source dimensions associated with the source multidimensional data model,
receive a selection of a target dimension from a plurality of target dimensions associated with the target multidimensional data model, thereby indicating a dimension mapping between the source dimension and the target dimension,
receive a selection of at least one source dimension member from a plurality of source dimension members associated with the source dimension,
receive a selection of a target dimension member from a plurality of target dimension members associated with the target dimension, thereby indicating a member mapping between the at least one source dimension member and the target dimension member, and
store the source selection, the target selection, the dimension mapping, and the member mapping.

10. The system of claim 9, wherein the instructions further cause the processor to
display the plurality of source dimensions and the plurality of target dimensions, and
display the plurality of source dimension members and the plurality of target dimension members.

11. The system of claim 9, further comprising:
a database, wherein the source selection, the target selection, the dimension mapping, and the member mapping are stored therein.

12. The system of claim 9, wherein the instructions further cause the processor to
receive a selection of a second source dimension,
receive a selection of a dimension member of the second source dimension, thereby indicating a dimension scope, and
storing the dimension scope for the second source dimension.

13. The system of claim 9, wherein the instructions further cause the processor to utilize the source selection, the target selection, the dimension mapping, and the member mapping to copy data from the source multidimensional data model to the target multidimensional data model.

14. The system of claim 13, wherein copying data includes
utilizing the source selection, the target selection, the dimension mapping, and the member mapping to build a query, and
executing the query to copy data from the source multidimensional data model to the target multidimensional data model.

15. The system of claim 9, wherein receiving a selection of at least one source dimension member includes
receiving a selection of a plurality of source dimension members, and
receiving a selection of an aggregation function for mapping the plurality of source dimension members to the target dimension member.

16. A computer storage medium storing computer-executable instructions which, when executed by a computer, cause the computer to:
retrieve the multidimensional data model association, wherein the multidimensional data model association includes
a source data model,
a target data model,
a plurality of dimension mappings, and
a plurality of member mappings;
generate one or more executable statements in order to copy data from the source data model to the target data model;
utilize the plurality of dimension mappings and the plurality of member mappings when generating the one or more executable statements; and
executing the executable statements.

17. The computer storage medium of claim 16, wherein the one or more executable statements comprise a structured query language (SQL) statement.

18. The computer storage medium of claim 16, wherein the one or more executable statements comprise a stored procedure.

19. The computer storage medium of claim 16, wherein the computer-executable instructions further cause the computer to, prior to generating one or more executable statements, determine that the one or more executable statements are in need of an update.

20. The computer storage medium of claim 16, wherein the computer-executable instructions further cause the computer to store the one or more executable statements with the multidimensional data model association.
